(19) United States
(12) Patent Application Publication
(10) Pub. No.: US 2016/0272023 A1
(43) Pub. Date: Sep. 22, 2016

(54) TOW BAR FOR LEVERAGING FORCE FROM A TUG

(71) Applicant: ALAIN ABRAHANTE, Miami, FL (US)

(72) Inventor: ALAIN ABRAHANTE, Miami, FL (US)

(21) Appl. No.: 14/661,602

(22) Filed: Mar. 18, 2015

(51) Int. Cl. B60D 1/155; B60D 3/00

(52) U.S. Cl. CPC B60D 1/155; B60D 3/00

(57) ABSTRACT

A tow bar for pushing and pulling a load with a tug. The tow bar hingedly attaches to the tug and leverages the force of the tug along its longitudinal axis onto the load. This enables movement of heavier loads. The tow bar includes a linear, rigid rod having a proximal end and a distal end. The distal end includes a cross bar with a flange for engaging with the load. The proximal end hingedly joins with the tug. A latch member mounts on a first end of a faceplate on the tug and detachably attaches to the distal end of the rod. A latch pin releases the distal end to pivot between an operational horizontal position and a stowed vertical position. A hinge member positions at a second end of the faceplate. The proximal end of the rod pivots about a hinge pin at the hinge member.

### BACKGROUND

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The present invention is directed to a tow bar for pushing and pulling a load with a tug.

The inventor has been loading and unloading luggage and cargo onto dollies for a number of years. Generally, the dollies are loaded with heavy cargo and luggage. The dolly must be pushed and pulled to and from the airplane, where an elevator positions the dolly and the accompanying load into its respective position in the cargo hold of the airplanes belly. The loads can weigh up to many tons, and require great physical exertion, which was taxing on the inventor's back.

The inventor recognized a problem in that manually pushing and pulling the dolly into position created excessive torque on the spine and feet. The inventor also noticed that hands and feet often got caught between dollies and between the dolly and aircraft. However, the only way to move the dollies into position for loading and unloading was to manually push them.

The inventor wondered if a simple machine could be used to leverage the pushing and pulling forces applied onto the dolly. The inventor investigated and found that a linear, rigid rod could more effectively push the load. This was because the force traveled along the longitudinal axis of the rod and leverage the force. The fulcrum for this lever, i.e., rod, was the emanating source of the force.

Through trial and error, the inventor learned that by adding a flange to the distal end of the rod, a cable on the load could be hooked for pulling the load. Also, the flange could be shaped to mate with a slot on the underside of the dolly. The rod could then turn left or right for better control of the wheeled dolly.

However, the inventor noticed that even with the rod, a great amount of pressure was applied to the back. The inventor realized that if the proximal end of the rod was attached to a stronger more automated force, the back could be saved from further damage. The inventor knew that tugs were used throughout the airport. The inventor attached the proximal end of the rod to the front end of the tug. Thus with the rod extended between the tug and the load, this created an effective lever tool for pushing and pulling the load.

However, after work the fully extended rod was cumbersome and occupied too much space. Through additional research, the inventor learned that a hinge at the distal end of the rod would allow the rod to pivot parallel to the face of the tug, such that it was out of the way.

Unfortunately, the rod would not stay into place in this stowed vertical position. The inventor decided to mount a latch onto the tug and pass a pin through the latch and the distal end of the rod to secure it into place. When the rod was needed for operation, the inventor would remove the pin to pivotally release the rod into the operational horizontal position.

For the foregoing reasons, there is a tow bar that is configured to push and pull a dolly with a tug. The tow bar hingedly attaches to the tug and exerts leverage along its longitudinal axis onto the load to maximize the force of the tug and negate the need for manually moving the dolly.

Tow bars have been utilized in the past; yet none with the present multiple positions and force leveraging capacity allowed by the present invention. See U.S. Pat. No. 4,555,214; U.S. Pat. No. 7,506,889; and U.S. Pat. No. 2,601,992.

For the foregoing reasons, there is a tow bar for pushing and pulling a load with a tug that leverages the force of a tug onto the load and pivots between an operational position and a stowed position.

### SUMMARY

The present invention describes a tow bar for leveraging force from a tug. The tow bar may be specifically configured for pushing and pulling a load with a tug, as those used at airports. The tow bar hingedly attaches to the tug and exerts leverage along its longitudinal axis onto the load to maximize the force of the tug. This linear leverage applied by the tow bar enables the movement of heavier loads. In this manner, the load does not have to be moved by hand, which may reduce back, hand, foot, and finger injuries.

As described above, the tow bar hingedly attaches to the tug and engages the load while exerting leverage along its longitudinal axis to the load. The tug may include a vehicle that is used for pushing and pulling a load, a pushback, and a tractor. The load may include an aircraft dolly, a luggage dolly, or a trailer.

The tug may include a faceplate that attaches towards the forward moving direction of the tug. The faceplate is defined by a first end that orients upwardly, and a second end that orients downwardly towards the wheels of the tug. The rod pivots in relation to the faceplate to move between an operational horizontal position that is generally parallel to the faceplate, and a stowed vertical position that is generally perpendicular to the faceplate. The tow bar is configured to detachably attach to the faceplate for both operation and stowage.

The rod is defined by a proximal end, a distal end, and a longitudinal axis. The proximal end of the rod includes a proximal end pin hole that traverses across the rod. The distal end of the rod includes a distal end pin hole that traverses across the rod. The rod may include a metal composition and is generally linear. This configuration enables the rod to exert leverage along the longitudinal axis. For example, the rod pivots to the horizontal position for pushing or pulling the load. In one alternative embodiment, the rod telescopically extends and retracts.

In some embodiments, the tow bar further comprises a cross bar. The cross bar attaches perpendicularly to the distal end of the rod. The cross bar forms a tool that helps grasp and hook onto the load. The cross bar includes a flange that extends outwardly, forming a substantially L-shape. In one embodiment, the flange is configured to mate with a slot in the dolly for secure attachment during pushing and pulling.

In some embodiments, the tow bar further comprises a latch member. The latch member is disposed to mount on the first end of the faceplate. The latch member is defined by a first mounting plate having at least one first fastening aperture. A first fastener, such as a bolt may pass through the first fastening aperture to fasten the latch member to the first end of the faceplate. A pair of spaced-apart latch plates are disposed to extend generally perpendicular from the first mounting plate. The pair of spaced-apart latch plates may include a latch pin hole.

A latch pin is configured to pass through the latch pin hole and the distal end pin hole; wherein the latch pin detachably attaches the distal end of the rod to the latch member. When removed from the pin holes, the latch pin releases the distal end of the rod from the latch member to enable the rod to pivot to the horizontal position. Conversely, when passed through the pin holes, the latch pin retains the rod in the vertical position for stowage. The latch pin may include a pin bracket that prevents the latch pin from disengaging from the pin holes.

In some embodiments, the tow bar further comprises a hinge member. The hinge member is disposed to mount on the second end of the faceplate. The hinge member is defined by a second mounting plate having at least one second fastening aperture. A second fastener, such as a bolt may pass through the second fastening aperture to fasten the hinge member to the second end of the faceplate. A pair of spaced-apart hinge plates are disposed to extend generally perpendicular from the second mounting plate. The pair of spaced-apart hinge plates may include a hinge pin hole.

A hinge pin is configured to pass through the hinge pin hole and the proximal end pin hole; wherein the rod pivots about the hinge pin between the vertical position and the horizontal position relative to the faceplate. When removed from the pin holes, the hinge pin releases the proximal end of the rod from the hinge member. Conversely, when passed through the pin holes, the hinge pin retains the rod in the vertical position. The latch pin may include a pin bracket that prevents the latch pin from disengaging from the pin holes.

One objective of the present invention is to provide a tow bar that attaches to a tug for pushing and pulling a dolly to an aircraft.

Another objective of the present invention is to eliminate the need to manually push and pull the dolly by hand.

Another objective of the present invention is to reduce back, hand, feet, and fingers injuries caused by manually moving the load.

Another objective of the present invention is to leverage the force of the tug along the longitudinal axis of the rod to effectively push and pull the load.

Another objective of the present invention is to selectively pivot the rod between an operational horizontal position and a stowed vertical position.

Another objective of the present invention is to retain the rod in the vertical position through a detachable latch pin.

Yet another objective of the present invention is to hook onto a cable from the dolly with the cross bar.

Yet another objective is to mate with a slot in the dolly with the flange on the cross bar.

One advantage of the present invention is that the rod is sufficiently rigid so as to exert leverage on the load while pushing and pulling.

Another advantage of the present invention is that the rod may telescopically extend and retract to adjustably engage variously sized and dimensioned loads.

Yet another advantage of the present invention is that the latch member and the hinge member easily mount to the faceplate on the tug.

Yet another objective is to provide an inexpensive to manufacture tow bar that universally operates with different types of tugs and dollies.

### DRAWINGS

These and other features, aspects, and advantages of the present invention will become better understood with regard to the following description, appended claims, and drawings where:

FIG. 1 is a perspective view of an exemplary tow bar in a stowed vertical position;

FIG. 2 is a perspective view of the tow bar in an operational horizontal position;

FIGS. 3A and 3B are elevated side views of the tow bar, where FIG. 3A is the tow bar in the vertical position, and FIG. 3B is the tow bar in the horizontal position;

FIGS. 4A and 4B are top views of the tow bar, where FIG. 4A is the tow bar in the vertical position, and FIG. 4B is the tow bar in the horizontal position;

FIGS. 5A, 5B, and 5C are blowup views of the distal and proximal ends of the tow bar engaging a latch member and a hinge member, where FIG. 5A is the tow bar in the horizontal position, FIG. 5B is the hinge member and the proximal end of a rod, and FIG. 5C is a cross bar and a distal end of the rod;

FIG. 6 is a sectioned side view of an exemplary tug with the tow bar in the vertical position;

FIG. 7 is a sectioned side view of the tug with the tow bar in the horizontal position; and

FIG. 8 is a sectioned side view of the tug with the tow bar in the horizontal position engaging an exemplary load.

### DESCRIPTION

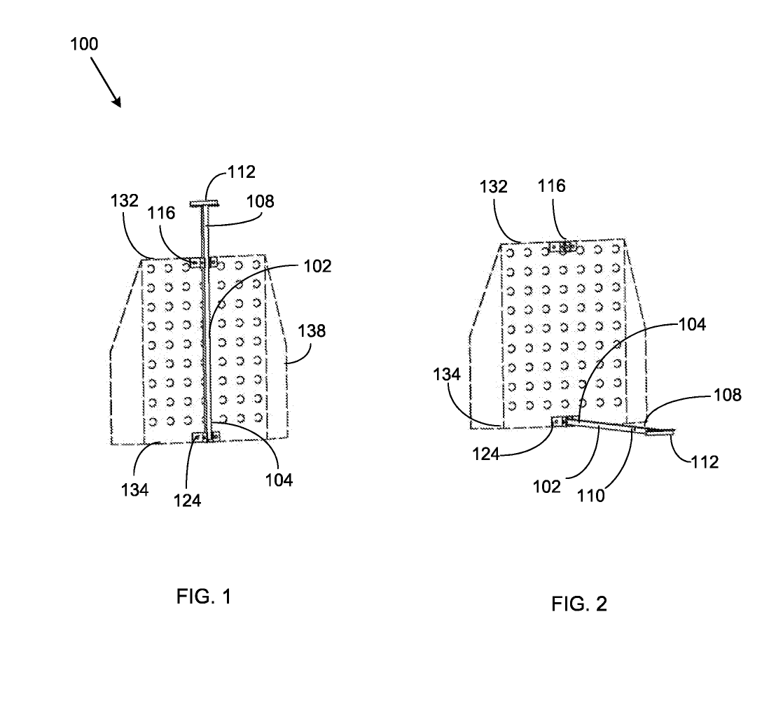

The present invention, referenced in FIGS. 1-8, is directed to a tow bar 100 for leveraging force from a tug 136. The tow bar 100 may be specifically configured for pushing and pulling a load 130 with a tug 136, as those used at airports. The tow bar 100 hingedly attaches to the tug 136 and exerts leverage from the force of the tug along its longitudinal axis onto the load 130. In this manner, the force, i.e., forward, rearward, and lateral movements of the tug 136 are maximized. Thus, this linear leverage enables the tow bar 100 to move heavier loads 130. Consequently, the load 130 does not have be moved manually, such that injuries to the back, hand, feet, and fingers may be reduced.

As referenced in FIG. 1, the tow bar 100 includes a linear, rigid rod 102 having a proximal end 104 and a distal end 108. The distal end 108 of the rod 102 includes a cross bar 112 with a flange 114 for engaging the load 130. The proximal end 104 of the rod 102 hingedly joins with the tug 136 to enable the rod 102 to pivot between an operational horizontal position and a stowed vertical position.

A latch member 116 mounts on a first end 132 of a faceplate 138 on the tug 136 and detachably attaches to the distal end 108 of the rod 102. A latch pin (not shown) passes through pin holes in the latch member and rod to release the distal end 108 of the rod 102 for pivoting between the horizontal position (FIG. 2) and the vertical position (FIG. 1). A hinge member 124 mounts on a second end 134 of the faceplate 138. A hinge pin 122 passes through the hinge member 124 and the rod 102. The proximal end 104 of the rod 102 pivots about the hinge pin 122 between the horizontal and vertical positions.

The rod 102 hingedly attaches to a tug 136 while simultaneously engaging the load 130. The rod 102 exerts leverage along its longitudinal axis from the force, i.e., forward and rearward motion, of the tug. In general, the tug 136 is configured to engage a generally heavy load 130, such as a dolly that is commonly used to transport luggage to and from an aircraft. The tug 136 may include a vehicle that is used for pushing and pulling a load 130, such as an automated tug 136, a pushback, a truck, or a tractor. The tug 136 may also have two, three, four, or more wheels. The load 130 may also include, without limitation, a dolly, a luggage dolly, an aircraft, a 20′ container, and a trailer.

As shown in FIG. 2, the tug 136 has a faceplate 138 that attaches towards the forward moving direction of the tug 136. The faceplate 138 is defined by a first end 132 that orients upwardly, and a second end 134 that orients downwardly towards the wheels of the tug 136. The rod 102 pivots in relation to the faceplate 138 to move between an operational horizontal position that is generally parallel to the faceplate 138, and a stowed vertical position that is generally perpendicular to the faceplate 138. The faceplate 138 may be integrated into the tug 136, or may be an aftermarket component that is operable with the tow bar 100.

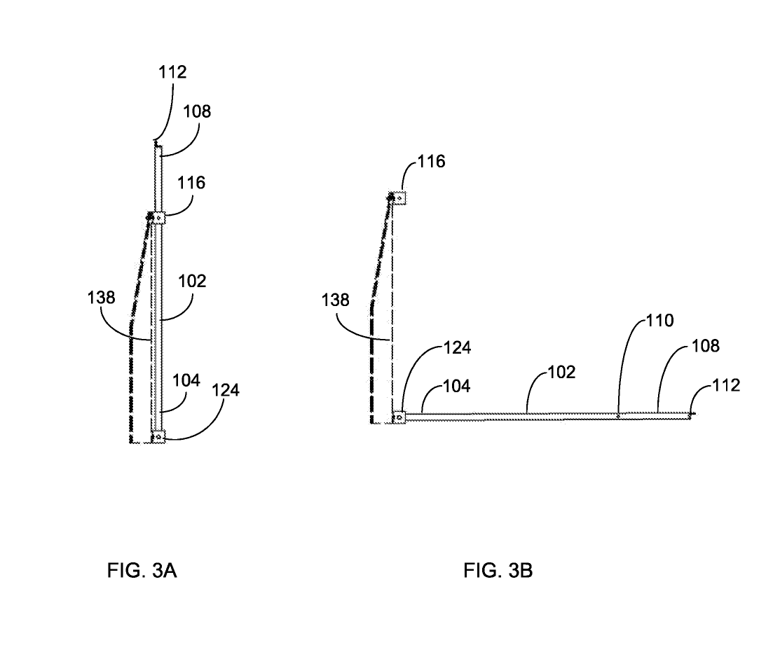

FIGS. 3A and 3B illustrate the rod 102, which is defined by a proximal end 104, a distal end 108, and a longitudinal axis. The proximal end 104 of the rod 102 includes a proximal end pin hole 106 that traverses through the rod 102. The proximal end pin hole 106 may have a circular shape that is configured to receive a pin, a screw, or a bolt. Similarly, the distal end 108 of the rod 102 includes a distal end pin hole 110 that traverses through the rod 102. The distal end pin hole 110 may have a circular shape that is configured to receive a pin, a screw, or a bolt.

The rod 102 may include a metal composition and be generally linear. This substantially rigid configuration enables the rod 102 to exert leverage along the longitudinal axis. For example, the rod 102 pivots to the horizontal position for pushing or pulling the load 130. Additionally, the tug 136 may turn in multiple directions to engage the rod 102 against the load 130. Suitable materials for the rod 102 may include, without limitation, steel, iron, aluminum, metal alloys, and rigid polymers.

In one alternative embodiment, the rod 102 telescopically extends and retracts to adjustably engage variously sized and dimensioned loads 130, and to adjustably move the load 130 from different positions. In yet another alternative embodiment, the rod 102 deviates from the linear configuration to form a slight angle. This angle provides additional positions from which to better control the load 130.

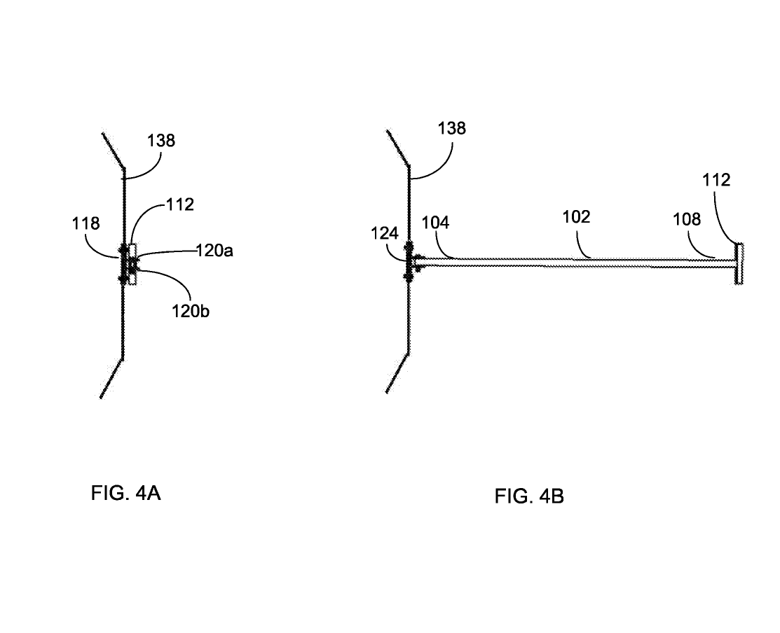

Turning now to FIGS. 4A and 4B, the tow bar 100 further comprises a cross bar 112. The cross bar 112 forms a tool at the terminus of the distal end 108 that helps grasp the load 130 for both pulling and pushing. The cross bar 112 attaches perpendicularly to the distal end 108 of the rod 102 to provide numerous advantages. For example, the cross bar 112 forms a wide base for pushing the load 130; a pair of free ends for hooking a cable on the load 130; and a specifically designed shape for mating with the underside slot of a load 130, such as a wheeled dolly. But in one embodiment, the cross bar 112 may be effective in hooking onto a strap that ties down cargo and luggage on a dolly.

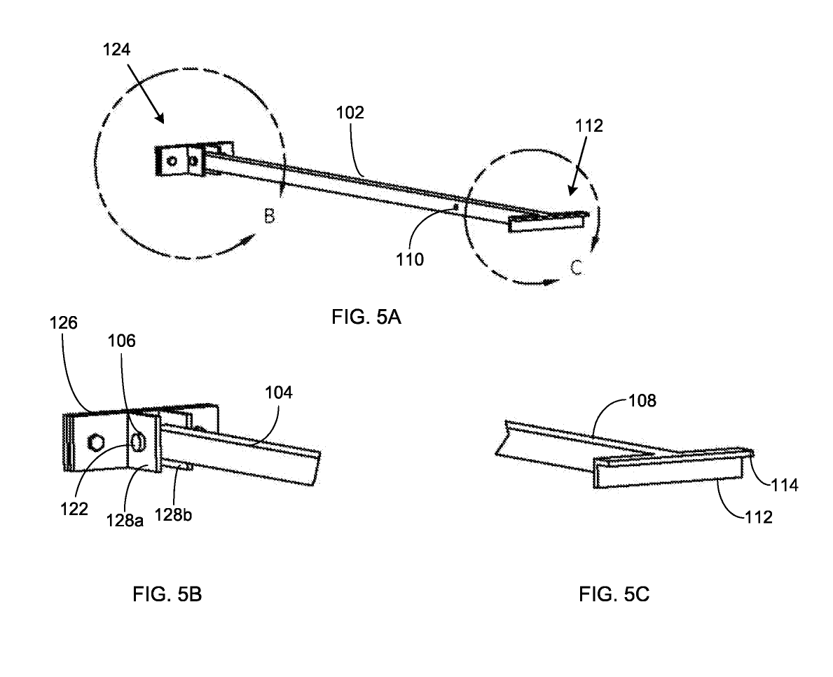

In some embodiments, the cross bar 112 may include a flange 114 that extends outwardly, forming a substantially L-shape (FIG. 5C). In one embodiment, the flange 114 is configured to mate with a slot in the dolly. This forms a secure attachment that enables the rod 102 to push and pull the load 130 without disengaging. In some embodiments, a rope may be tied around the flange 114 for pulling or pushing a load 130. In one alternative embodiment, the flange 114 detaches from the cross bar 112.

As illustrated in FIG. 5A, the tow bar 100 further comprises a latch member 116. The latch member 116 is disposed to mount on the first end 132 of the faceplate 138. The latch member 116 is defined by a first mounting plate 118. The first mounting plate 118 may include a square metal plate that engages the faceplate 138, flush. The first mounting plate 118 includes at least one first fastening aperture (not shown). A first fastener (not shown), such as a bolt or screw may pass through the first fastening aperture to fasten the latch member 116 to the first end 132 of the faceplate 138. However, in other embodiments, the first mounting plate 118 may be welded or magnetically attached to the first end 132 of the faceplate 138.

As detailed in FIG. 5B, a pair of spaced-apart latch plates 120a-b are disposed to extend generally perpendicular from the first mounting plate 118. The pair of spaced-apart latch plates 120a-b may include a latch pin hole (not shown). A latch pin (not shown) is configured to pass through both the latch pin hole and the distal end pin hole 110; wherein the latch pin detachably attaches the distal end 108 of the rod 102 to the latch member 116. When removed from the pin holes, the latch pin releases the distal end 108 of the rod 102 from the latch member 116 to enable the rod 102 to pivot between the horizontal and vertical positions. Conversely, when passed through the pin holes, the latch pin retains the rod 102 in the vertical position for stowage. In one embodiment, the latch pin includes a pin bracket that prevents the latch pin from disengaging from the pin holes.

In some embodiments, the tow bar 100 further comprises a hinge member 124. The hinge member 124 is disposed to mount on the second end 134 of the faceplate 138. The hinge member 124 is defined by a second mounting plate 126 having at least one second fastening aperture. A second fastener, such as a bolt or screw may pass through the second fastening aperture to fasten the hinge member 124 to the second end 134 of the faceplate 138. However, in other embodiments, the second mounting plate 126 may be welded or magnetically attached to the first end 132 of the faceplate 138.

A pair of spaced-apart hinge plates 128a-b are disposed to extend generally perpendicular from the second mounting plate 126. The pair of spaced-apart hinge plates 128a-b may include a hinge pin hole (not shown). A hinge pin 122 is configured to pass through the hinge pin hole and the proximal end pin hole 106. In this manner, the rod 102 pivots about the hinge pin 122 between the vertical and horizontal positions relative to the faceplate 138. The hinge pin 122 generally remains engaged in the pin holes for pivoting and support of the rod 102.

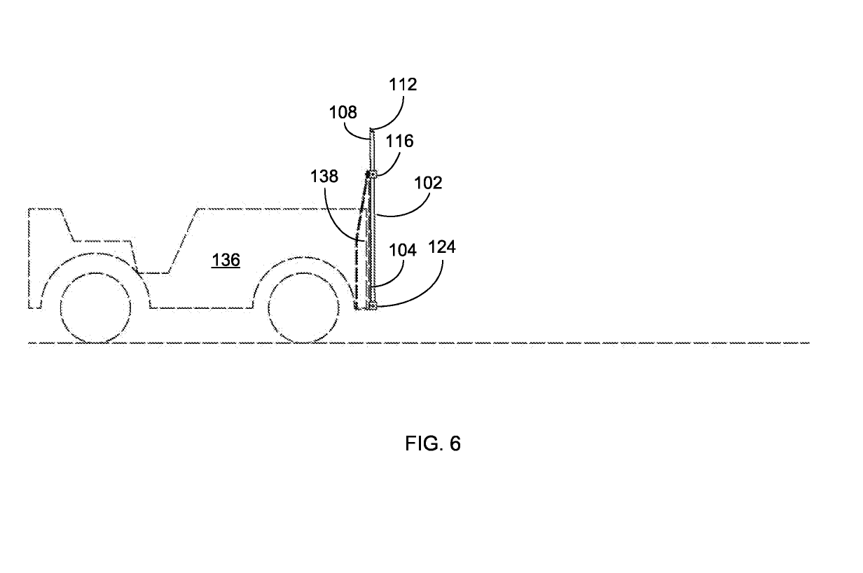

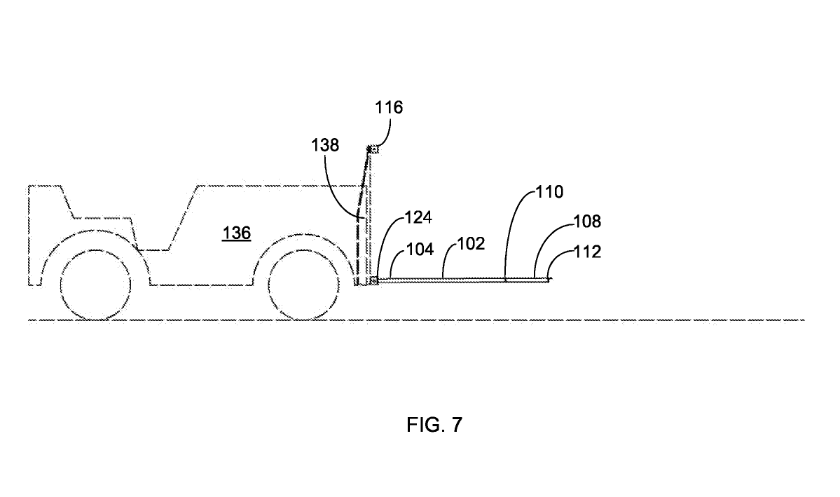

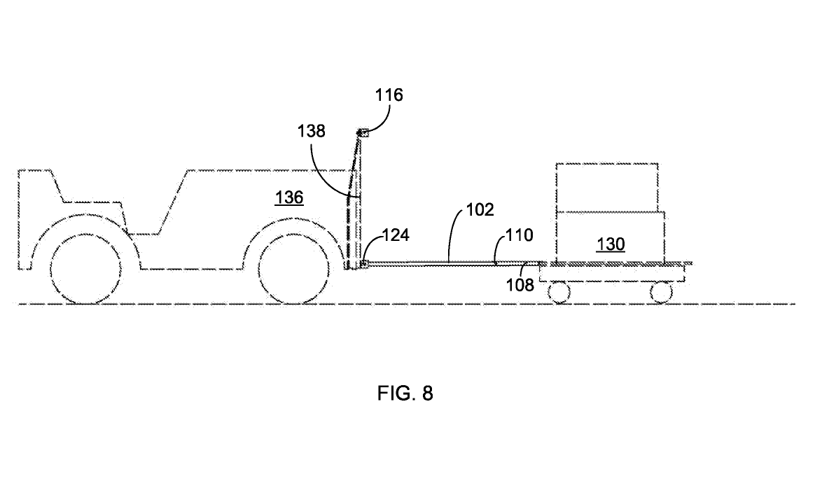

In operation, the tug 136 initially maintains the rod 102 in a vertical position during stowage (FIG. 6). The rod 102 occupies the least amount of space in the vertical position. By removing the latch pin, the rod 102 falls (or is pulled, depending on frictional disposition of the hinge pin 122) to the operational horizontal position (FIG. 7). From the horizontal position, the cross bar 112 may engage the load 130 for pulling and pushing (FIG. 8). The rod 102 is configured to leverage the force of the tug 136 onto the load 130 to manipulate and move the load 130, as desired.

While the inventor's above description contains many specificities, these should not be construed as limitations on the scope, but rather as an exemplification of several preferred embodiments thereof. Many other variations are possible. For example, the tow bar 100 may have additional holes for ropes and cables to pass through for greater flexibility on moving the load. Accordingly, the scope should be determined not by the embodiments illustrated, but by the appended claims and their legal equivalents.

What is claimed is:

1. A tow bar for pushing and pulling a dolly with a tug, the tow bar comprising:
a rod, the rod defined by a proximal end, a distal end, and a longitudinal axis, the proximal end having a proximal end pin hole, the distal end having a distal end pin hole,
wherein the rod is configured to exert leverage along the longitudinal axis;
a cross bar, the cross bar having a flange, the cross bar disposed to attach perpendicularly to the distal end of the rod;
a latch member, the latch member defined by a first mounting plate and a pair of spaced-apart latch plates, the pair of spaced-apart latch plates disposed generally perpendicular to the first mounting plate, the pair of spaced-apart latch plates having a latch pin hole;
a latch pin, the latch pin configured to pass through the latch pin hole and the distal end pin hole,
wherein the latch pin detachably attaches the distal end of the rod to the latch member;
a hinge member, the hinge member defined by a second mounting plate and a pair of spaced-apart hinge plates, the pair of spaced-apart hinge plates disposed generally perpendicular to the second mounting plate, the pair of spaced-apart hinge plates having a hinge pin hole; and
a hinge pin, the hinge pin configured to pass through the hinge pin hole,
wherein the hinge pin hingedly attaches the proximal end of the rod to the hinge member,
wherein the rod pivots about the hinge pin between a vertical position and a horizontal position.

2. The tow bar of claim 1, wherein the rod is configured to push and pull a load from the horizontal position.

3. The tow bar of claim 1, further including a tug faceplate, the tug faceplate defined by a first end and a second end.

4. The tow bar of claim 3, wherein the latch member mounts the first end of the faceplate.

5. The tow bar of claim 4, wherein the first mounting plate has at least one first fastening aperture.

6. The tow bar of claim 5, further including a first fastener configured to pass through the at least one first fastening aperture for mounting the latch member to the faceplate.

7. The tow bar of claim 6, wherein the hinge member mounts the second end of the faceplate.

8. The tow bar of claim 7, wherein the second mounting plate has at least one second fastening aperture.

9. The tow bar of claim 8, further including a second fastener configured to pass through the at least one second fastening aperture for mounting the hinge member to the faceplate.

10. The tow bar of claim 9, wherein the cross bar is configured to latch to a cable from the load.

11. The tow bar of claim 10, wherein the load is a dolly for carrying luggage to an aircraft.

12. The tow bar of claim 1, wherein the latch pin has a pin bracket.

13. The tow bar of claim 1, wherein the rod telescopically extends and retracts.

14. The tow bar of claim 1, wherein the flange of the cross bar is configured to engage a slot in the load.

15. The tow bar of claim 1, wherein the tow bar is metal.

16. A tow bar for pushing and pulling a dolly with a tug, the tow bar comprising:
a faceplate, the faceplate defined by a first end and a second end;
a rod, the rod defined by a proximal end, a distal end, and a longitudinal axis, the proximal end having a proximal end pin hole, the distal end having a distal end pin hole,
wherein the rod is configured to exert leverage along the longitudinal axis;
a cross bar, the cross bar having a flange, the cross bar disposed to attach perpendicularly to the distal end of the rod;
a latch member, the latch member disposed to mount on the first end of the faceplate, the latch member defined by a first mounting plate and a pair of spaced-apart latch plates, the pair of spaced-apart latch plates disposed generally perpendicular to the first mounting plate, the pair of spaced-apart latch plates having a latch pin hole;
a latch pin, the latch pin configured to pass through the latch pin hole and the distal end pin hole,
wherein the latch pin detachably attaches the distal end of the rod to the latch member;
a hinge member, the hinge member disposed to mount on the second end of the faceplate, the hinge member defined by a second mounting plate and a pair of spaced-apart hinge plates, the pair of spaced-apart hinge plates disposed generally perpendicular to the second mounting plate, the pair of spaced-apart hinge plates having a hinge pin hole; and
a hinge pin, the hinge pin configured to pass through the hinge pin hole,
wherein the hinge pin hingedly attaches the proximal end of the rod to the hinge member,
wherein the rod pivots about the hinge pin between a vertical position and a horizontal position relative to the faceplate.

17. The tow bar of claim 16, wherein the first mounting plate has at least one first fastening aperture.

18. The tow bar of claim 17, further including a first fastener configured to pass through the at least one first fastening aperture for mounting the latch member to the faceplate.

19. The tow bar of claim 18, wherein the second mounting plate has at least one second fastening aperture.

20. The tow bar of claim 19, further including a second fastener configured to pass through the at least one second fastening aperture for mounting the hinge member to the faceplate.
